(19) United States
(12) Patent Application Publication
(10) Pub. No.: US 2011/0051097 A1
(43) Pub. Date: Mar. 3, 2011

(54) SLIDE PROJECTOR

(75) Inventor: Hao-Lun LIN, Daliao Hsiang (TW)

(73) Assignee: GEMMY INDUSTRIES CORPORATION, Coppell, TX (US)

(21) Appl. No.: 12/551,401

(22) Filed: Aug. 31, 2009

(51) Int. Cl. G03B 21/14

(52) U.S. Cl. 353/46

(57) ABSTRACT

A slide projector has a case, a lens, a light source, a slide bracket and dynamic effect device. The lens is mounted on a front surface of the case. The light source is mounted on the opposite side to the lens in the case. The slide bracket is mounted between the lens and the light source. The dynamic effect device has a first motor and a first ripple glass. The first ripple glass is mounted between the light source and the slide bracket, and can be driven to rotate by the first motor. Light from the light source passes through the first ripple glass that is rotating. Light refracts and changes with rotation of the first ripple glass so the slide projector can project an image with a dynamic effect.

### BACKGROUND OF THE INVENTION

1. Field of the Invention

The present invention relates to a slide projector, and more particularly to a projector that can project an image with dynamic effect.

2. Description of Related Art

Slide projectors are used to project an image formed on a photographic slide onto a flat screen. Slide projectors are often used in classes, meetings, presentations and the like.

A conventional slide projector comprises a case, a lens, a light source and a slide bracket. The case has a front surface. The lens is mounted on the front surface of the case. The light source is mounted on the opposite side of the lens. The slide bracket is mounted between the lens and the light source.

When the slide projector is used, light from the light source passes through a transparent slide that is positioned by the slide bracket and the lens. The resulting image is enlarged by the lens and projected onto a flat screen.

Because the image projected by the conventional slide projector is static, the audience may become bored, an attention level decreases so an efficiency of learning is also decreases.

To overcome the shortcomings, the present invention provides a slide projector to mitigate or obviate the aforementioned problems.

### SUMMARY OF THE INVENTION

An objective of the invention is to provide a slide projector that projects an image with dynamic effect so that the attention of audience can be more concentrated.

A slide projector in accordance with the present invention has a case, a lens, a light source, a slide bracket and dynamic effect device. The lens is mounted on a front surface of the case. The light source is mounted on the opposite side to the lens in the case. The slide bracket is mounted between the lens and the light source. The dynamic effect device has a first motor and a first ripple glass. The first ripple glass is mounted between the light source and the slide bracket, and can be driven to rotate by the first motor. Light from the light source passes through the first ripple glass that is rotating. Light refracts and changes with rotation of the first ripple glass so the slide projector can project an image with a dynamic effect.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an embodiment of a slide projector in accordance with the present invention;

FIG. 2 is a sectional view showing the slide projector of FIG. 1;

FIG. 3 is a sectional view showing another embodiment of the slide projector with two motors and two ripple glasses;

FIG. 4 is a perspective view showing the slide projector with two motors and two ripple glasses, shown with a cover removed;

FIG. 5 is a partially exploded perspective view showing the slide projector with two motors and two ripple glasses;

FIG. 6 is a diagram showing a light path.

### DETAILED DESCRIPTION OF PREFERRED EMBODIMENT

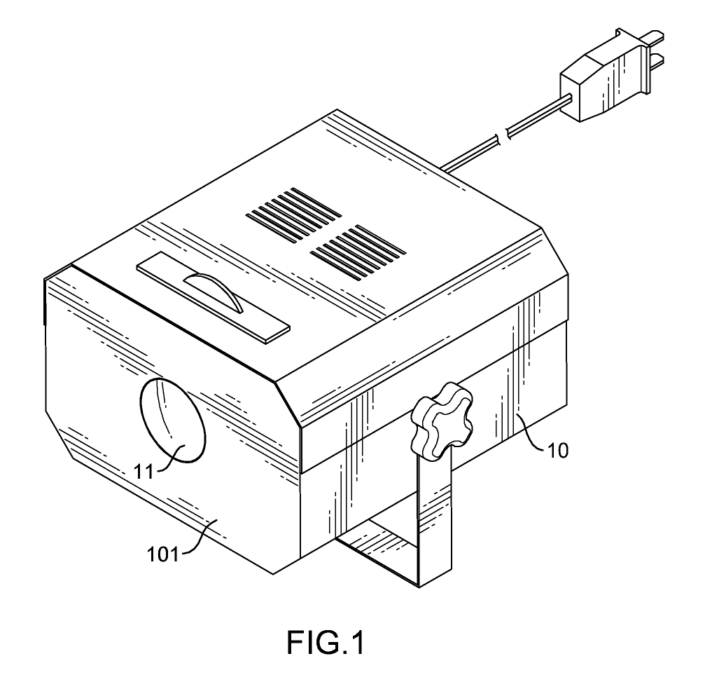

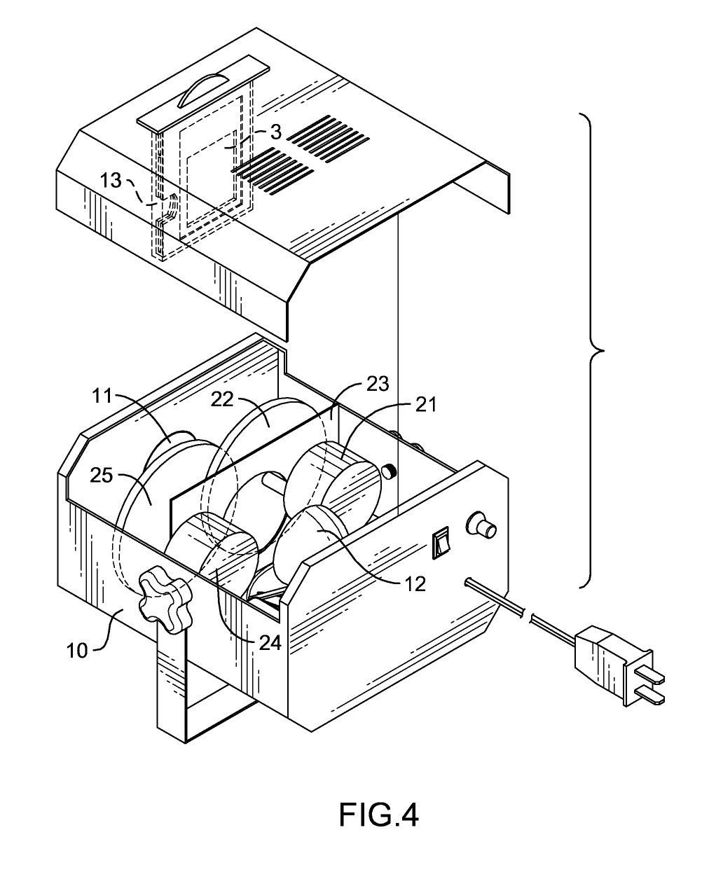

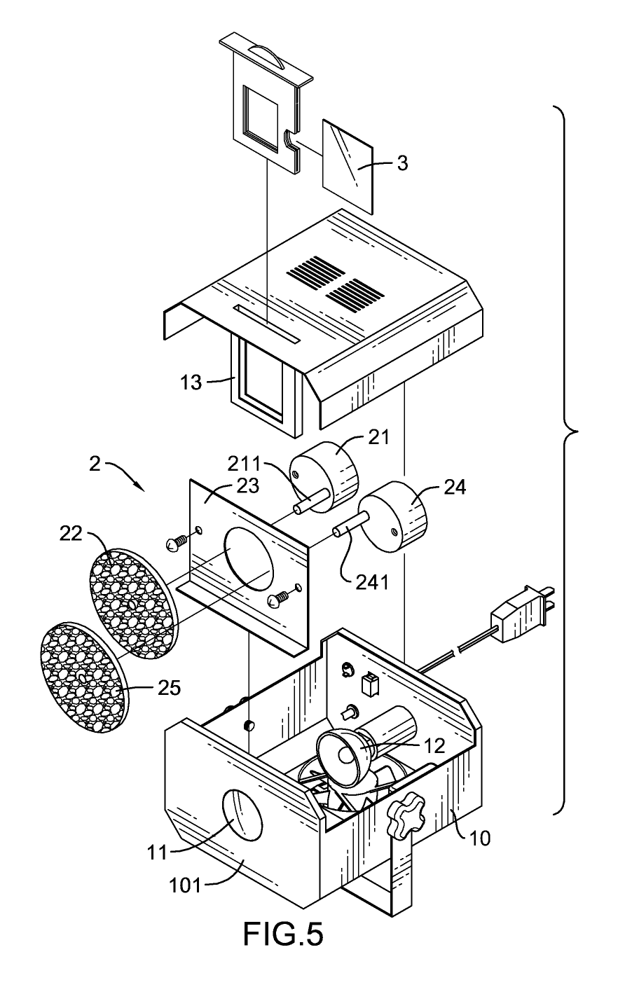

With reference to FIGS. 1 to 5, a slide projector in accordance with the present invention comprises a case (10), a lens (11), a light source (12), a slide bracket (13), and a dynamic effect device (2).

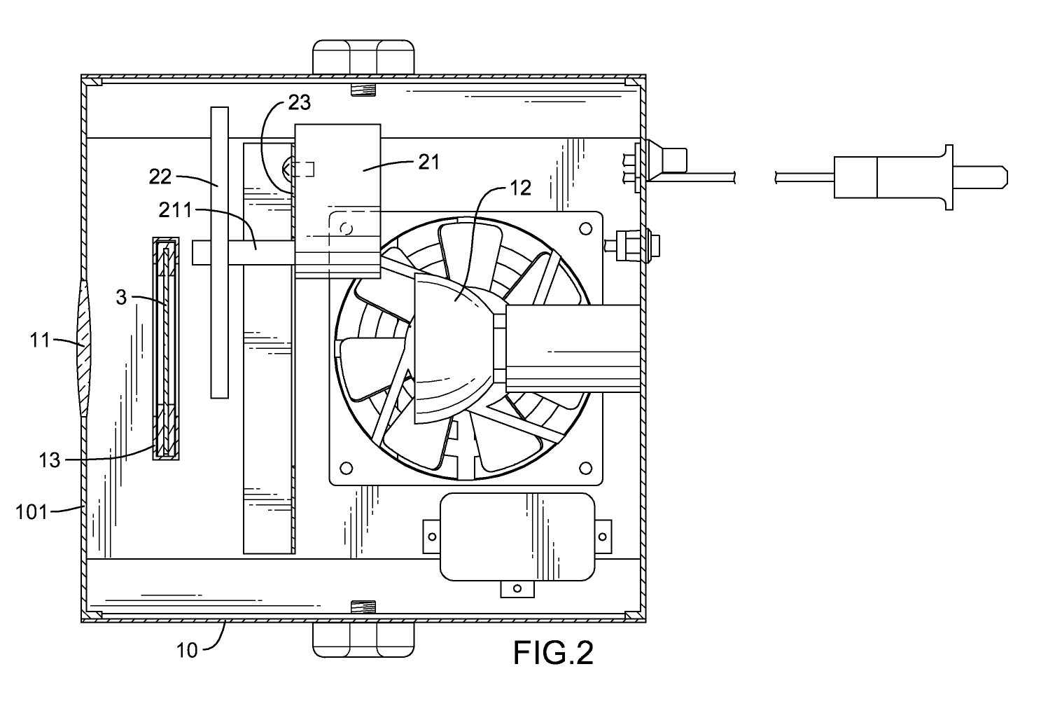

With reference to FIG. 1 to 2, the case (10) has a front surface (101), the lens (11) is mounted on the front surface (101). The light source (12) is mounted on the opposite side to the lens (11) in the case (10). The slide bracket (13) is mounted between the lens (11) and the light source (12).

The dynamic effect device (2) comprises a first motor (21), a first ripple glass (22) and further comprises a motor bracket (23). The first motor (21) has a first spindle (211) and is mounted on the motor bracket (23) that is mounted in the case (10). The first ripple glass (22) is mounted between the light source (12) and the slide bracket (13), and is connected to the first spindle (211). The first ripple glass (22) has many ripples formed thereon.

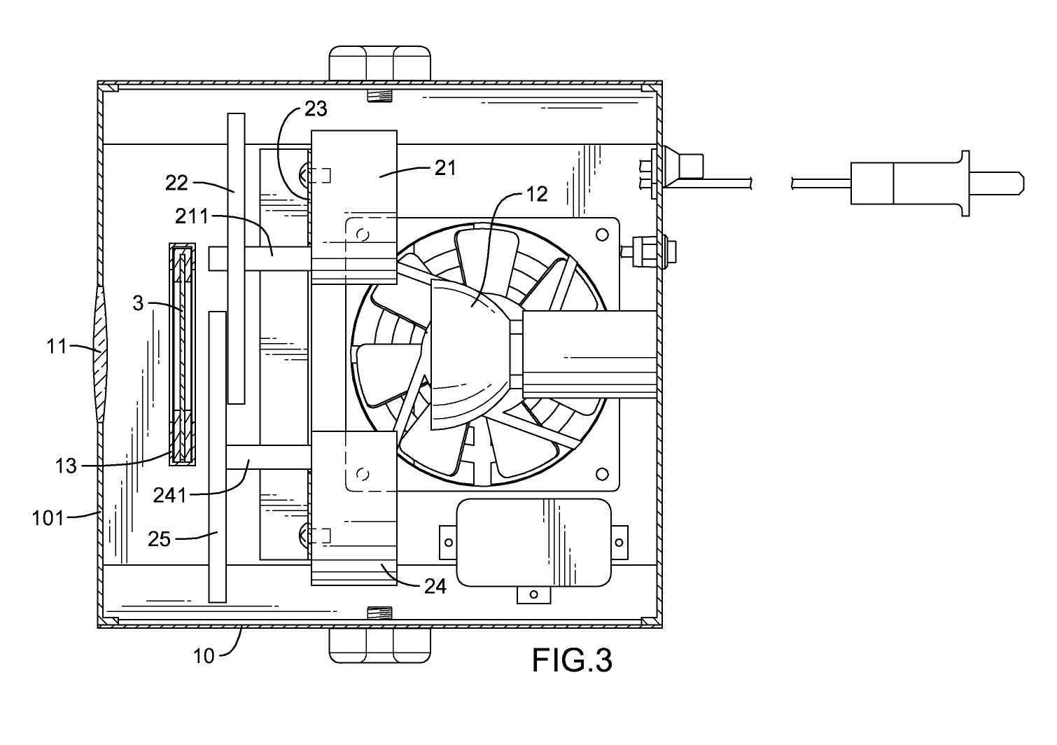

With reference to FIG. 3 to 5, the dynamic effect device (2) further comprises a second motor (24) and a second ripple glass (25). The second motor (24) is mounted on the motor bracket (23), and the second motor (24) has a second spindle (241). The second ripple glass (25) is mounted between the light source (12) and the slide bracket (13), and the second ripple glass (25) partially overlaps with the first ripple glass (22). The second ripple glass (25) is connected to the second spindle (241). The second ripple glass (25) has many ripples thereon.

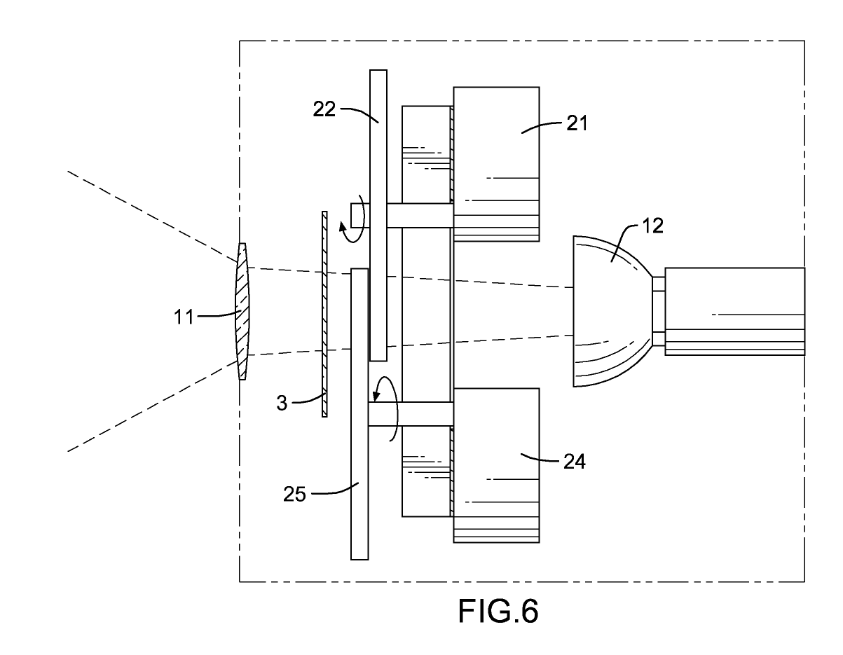

With reference to FIG. 6, light from the light source (12) passes through the first ripple glass (22), the second ripple glass (25), a slide (3) mounted in the slide bracket (13) and lens (11) in turn. When light passes through the first ripple glass (22) and the second ripple glass (25), light refracts because of the ripples. The first motor (21) and the second motor (24) drive the first ripple glass (22) and the second ripple glass (25) to rotate, and positions of the ripples change with time so that passing light has different intensity in different moment. The image that is projected to screen has a dynamic effect that changes with time.

The present invention provides a slide projector that can project an image with a dynamic effect. The background of the image is not static and constantly changes so improving concentrated of an audience in a class or meeting. The second motor (24) and the second ripple glass (25) can furthermore increase variation of the dynamic effect.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A slide projector comprising:
a case having a front surface;
a lens mounted on the front surface;
a light source mounted in the case opposite to the lens;
a slide bracket mounted between the lens and the light source; and
a dynamic effect device comprising
a first motor mounted in the case, having a first spindle;
a first ripple glass mounted between the light source and the slide bracket, connected to the first spindle and having multiple ripples formed thereon;

2. The slide projector as claimed in claim 1, the dynamic effect device further comprising:
a second motor mounted in the case and having a second spindle;
a second ripple glass mounted between the light source and the slide bracket, connected to the second spindle, partially overlapping the first ripple glass, and having multiple ripples formed thereon.

3. The slide projector as claimed in claim 1, wherein the dynamic effect device also comprises
a motor bracket mounted in the case, and the first motor mounted on the motor bracket.

4. The slide projector as claimed in claim 2, wherein the dynamic effect device also comprises a motor bracket mounted in the case, the first motor and the second motor mounted on the motor bracket.
